(19) United States
(12) Patent Application Publication
(10) Pub. No.: US 2009/0314836 A1
(43) Pub. Date: Dec. 24, 2009

(54) AUTOMATIC PRINT JOB TRACKING

(75) Inventors: Pravin N. Kothari, Poughkeepsie, NY (US); Mark Steven Amico, Pittsford, NY (US); Paul Allen Hosier, Rochester, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/141,173

(22) Filed: Jun. 18, 2008

(51) Int. Cl. G06Q 99/00

(52) U.S. Cl. 235/385

(57) ABSTRACT

A system for automatically tracking documents printed from a printing device includes a database adapted to maintain data corresponding to the identity and location of at least one document. The at least one document has at least one page. A processor is in operative communication with the database to provide a document file containing both a printable content and an RFID taggable content. The processor is configured to provide the printable content to the printing device and the taggable content to an RFID tag writer. The RFID tag writer is adapted to install diagnostic data corresponding to the printing device on at least one of a first RFID tag and a second RFID tag and security data corresponding to the at least one document on at least one of the first and second RFID tags. A container is configured to retain the at least one document and an RFID tag dispenser is configured to attach the first RFID tag to at least one page of the at least one document and the second RFID tag to at least one page of the at least one document.

### BACKGROUND

1. Technical Field

The present disclosure relates to printing systems and methods, and, in particular, to a system and method for automatically recording and tracking print jobs from a printing device.

2. Description of Related Art

RFID is a method for automatic identification which uses radiofrequency (RF) signals. A device known as an RFID interrogator which includes an RFID writer and/or a RFID reader, wirelessly reads, and optionally, writes data stored in a transponder, known as an RFID tag, that is physically attached to an article, such as a product, packaging or shipping container. Typically, an RFID tag consists of two main components: an integrated circuit (IC) for storing and processing data and for modulating and demodulating the RF signal, and an antenna coupled to the chip that enables the chip to exchange data between the tag and interrogator. An RFID tag can be read-only, wherein the IC contains unalterable data, such as a unique identification code indelibly encoded by the tag manufacturer which is used to uniquely identify the tag. Alternatively, an RFID tag can be read-write, wherein the stored data can be changed or deleted. Typically, however, a read-write RFID tag will also contain read-only data, such as an indelible unique identification code, so that individual tags can be uniquely identified.

RFID tags ordinarily range in sizes from several inches to sizes no larger than a grain of rice. RFID tags can be constructed using an essentially planar form factor and incorporated into a self-adhesive label, for example. It is expected the ability to print RFID tags, much like a barcode is printed, will eventually become widespread using, for example, techniques developed by Xerox for depositing liquid polythiophene semiconductors onto a surface at room temperature.

RFID systems typically employ either far-field technology, in which the distance between the reader and the tag is great compared to the wavelength of the carrier signal, or near-field technology, in which the operating distance is less than one wavelength of the carrier signal, to facilitate communication between the RFID reader and RFID tag. In far-field applications, the RFID reader generates and transmits an RF request signal via an antenna to all tags within range of the antenna. One or more of the tags that receive the RF signal responds to the reader using a backscattering technique in which the tags modulate and reflect the received RF signal. In near-field applications, the RFID reader and tag communicate via mutual inductance between corresponding reader and tag inductors.

### SUMMARY

In an embodiment of the present disclosure, a system for automatically tracking documents printed from a printing device includes a database adapted to maintain data corresponding to the identity and location of at least one document. The at least one document has at least one page. A processor is in operative communication with the database to provide a document file containing both a printable content and an RFID taggable content. The processor is configured to provide the printable content to the printing device and the taggable content to an RFID tag writer. The RFID tag writer is adapted to install diagnostic data corresponding to the printing device on at least one of a first RFID tag and a second RFID tag and security data corresponding to the at least one document on at least one of the first and second RFID tags. A container is configured to retain the at least one document and an RFID tag dispenser is configured to attach the first RFID tag to at least one page of the at least one document and the second RFID tag to at least one page of the at least one document.

According to another embodiment of the present disclosure, a system for automatically tracking print jobs printed from a printing device includes a database adapted to maintain data corresponding to the identity and location of at least one print job. The print job includes at least one page. A processor is in operative communication with the database to provide a document file containing both a printable content and an RFID taggable content. The processor is configured to provide the printable content to the printing device and the taggable content to an RFID tag writer. The RFID tag writer is adapted to install diagnostic data corresponding to the printing device on at least one of a first RFID tag and a second RFID tag and security data corresponding to the at least one print job on at least one of the first and second RFID tags. A container is configured to retain the at least one print job and an RFID tag dispenser is configured to attach the first and second RFID tags to the at least one page of the at least one print job. At least one RFID tag reader is configured to read at least one of the first and second RFID tags to track the movement of the at least one print job.

The present disclosure also provides for a method for automatically tracking documents printed from a printing device. The method includes maintaining data corresponding to the identity and location of at least one document having at least one page and providing a printable content to the printing device and a taggable content to an RFID tag writer. The method also includes installing diagnostic data corresponding to the printing device on at least one of a first RFID tag and a second RFID tag and security data corresponding to the at least one document on at least one of the first and second RFID tags. The method also includes retaining the at least one document in a container and attaching the first RFID tag to at least one page of the at least one document and the second RFID tag to at least one page of the at least one document. The method also includes reading at least one of the first and second RFID tags to track the movement of the at least one document.

### BRIEF DESCRIPTION OF THE DRAWINGS

These and other advantages will become more apparent from the following detailed description of the various embodiments of the present disclosure with reference to the drawings wherein:

FIG. 1 is a schematic view of a typical RFID tag;

FIG. 2 is a similar view of an RFID tag and associated reader;

FIG. 3 is a schematic view of a system for automatically tracking printed documents employing an RFID enable printer; and

FIG. 4 is a similar view illustrating components and operation of an RFID enable printer.

### DETAILED DESCRIPTION

Embodiments of the presently disclosed advertisement system will now be described in detail with reference to the drawings in which like reference numerals designate identical or corresponding elements in each of the several views.

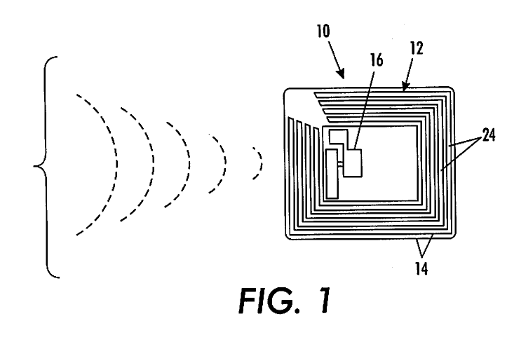

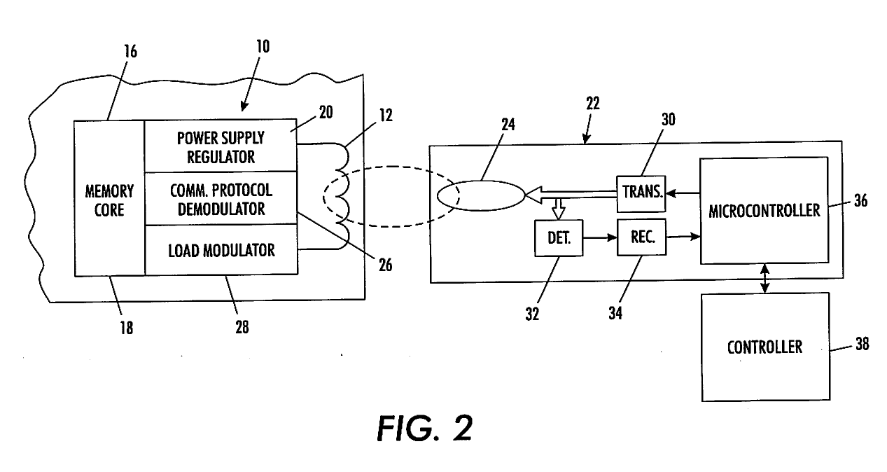

Referring to FIGS. 1 and 2, there is shown a typical RFID tag 10 for use in a system for automatically tracking printed documents and/or, more specifically, print jobs. The tag 10 includes a tag antenna 12 composed of a plurality of antenna elements 14 which, in this particular embodiment, are wound in a substantially rectangular pattern and connected to an integrated circuit chip 16, also known as a radio frequency identification chip. Within the tag 10, data storage and processing as well as radio frequency (RF) communication functions are performed by the RF identification chip 16.

As shown in FIG. 2, the chip 16 is a passive type and may include, for example, a memory core 18 (e.g. an EEPROM or flash memory), which stores the data, a power supply regulator 20, which rectifies and otherwise conditions alternating current induced in the antenna 12 by a time-varying RF signal provided by a reader or coupler 22 and its antenna 24 for use in the tag 10 as a direct current power source, and receiver/emitter modules 26, 28 (e.g., compatible with the ISO 14443 standard).

The reader 22 includes a transmitter 30 that generates the time-varying RF signal transmitted by the antenna 24. As a result of electromagnetic coupling between the tag antenna 12 and the reader antenna 24, a portion of the RF signal transmitted by the tag antenna 12 enters the reader antenna 24 and is separated from the transmitted signal by a detector 32 (e.g., an envelope detector). The separated signal is passed to a receiver 34, where it is amplified, decoded and presented via a microcontroller 36 to a controller 38, which may be a host computer, for example.

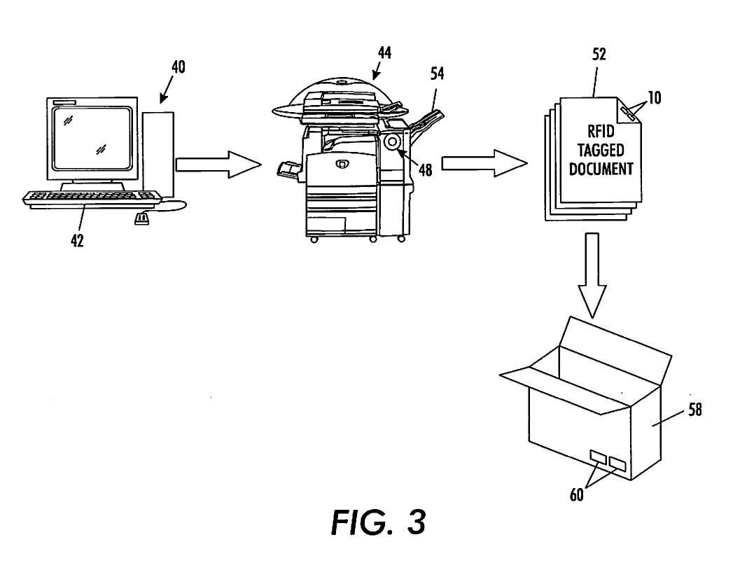

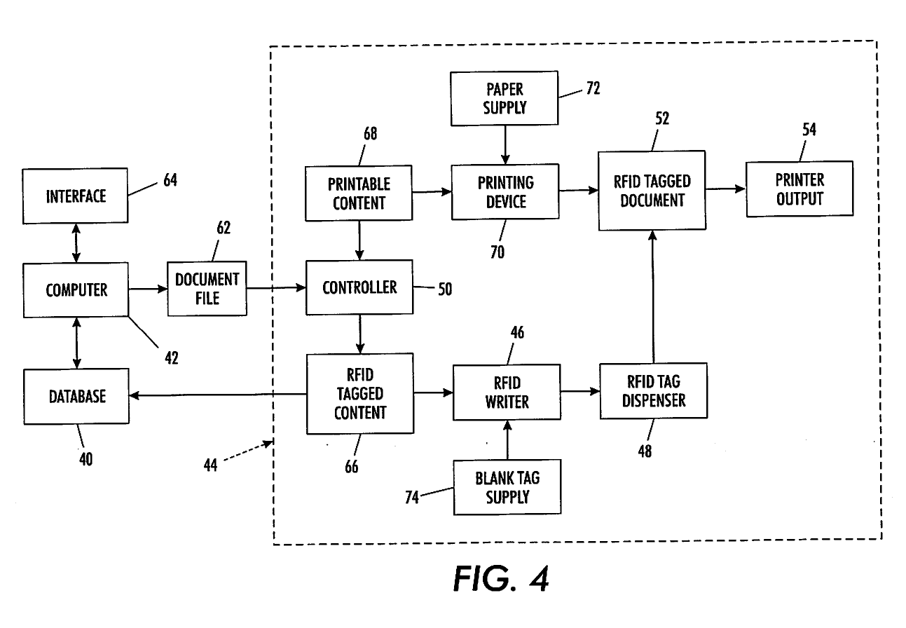

Referring now to FIGS. 3 and 4, there is shown an RFID system for automatically tracking printed documents in a typical office environment. The system includes a database 40, which may be created and maintained by a host computer 42, and an RFID enabled printer 44. The printer 44 may be any standard type office printer equipped with the usual components, such as a marking device, toner, fuser rolls and media supply such as plain paper sheets. However, the printer 44, in this case, is equipped with an RFID writer 46 (see FIG. 4), an RFID tag dispenser 48 and a print controller 50. The print controller 50 is configured to handle the RFID indexing data or taggable content as well as the usual print content for printing the documents 52. Print content may include, for example, a printed bar code or a glyph that includes information identical to the taggable content on a given document 52 (i.e., a duplicate of the taggable content), or a symbol, text, or graphic that conveys the taggable content. The RFID tag dispenser 48 may be a separate unit for attaching or printing one or more RFID tags 10 directly onto the documents 52 or the tag dispenser and RFID writer may be combined into a single unit as shown in FIG. 3. The documents 52 may be, for example, a print job having multiple pages and or books, a document book having one or more pages, or the like.

In the illustrated embodiment, a pair of RFID tags 10 are applied to the printed documents 52 after the documents have been printed (e.g., via a so-called “interposer tray) but before they exit the printer 44, usually via an output station 54. In embodiments, the pair of RFID tags 10 may be applied to the printed documents 52 during the flow of printing (e.g., while in the so-called “stacker”) or prior to printing (e.g., via a so-called “feeder tray”). RFID tags 10 may be placed onto only the first page of the document or a print job (e.g., title page), on all pages of a print job, a random page of a print job, or a last page of a print job, for example. As shown in FIG. 3, a pair of tags 10 is placed on the backside of the printed document 52 as shown by the folded-down right hand corner facing the front of the document. This location is ideal since it is non-intrusive to reading or handling of the document and yet is readily accessible to both the RFID writing and reading processes.

Once an RFID tag 10 has been printed and attached to a document 52 for a given print job, the document 52 and/or print job may be transferred to a transport container 58 for subsequent delivery, sorting, handling, distribution, and/or shipment to a customer. Typical transport containers that may be used include various types of boxes, containers, binders, jackets, dockets, envelopes, clips, bi-fold, side-fold, expandable and tri-fold file folders, and generally anything that can retain or hold together a plurality of printed documents.

Alternatively or additionally, one or more separate RFID tags 60 is then attached to the transport container 58 to identify the container as well as the documents and/or print jobs therein. The RFID tags 60 can also be employed to identify a particular class or category of files, documents, print jobs, or the like, kept inside the container 58.

Advantageously, by providing a pair of RFID tags 10 on the document 52 and/or a pair of RFID tags 60 on the container 58, a first tag may be utilized to store diagnostic information, while a second tag may be utilized to store security information (e.g., RFID tags 60 on the container 58 may be utilized to control security of documents and/or ensure proper delivery and record keeping after processing and distribution of printed jobs, etc.). For example, the first tag may include diagnostic information regarding the printing process and/or printer 44 from which the document 52 was printed and tagged. Diagnostic information regarding the printing process and/or printer 44 may include, for example, a printer number, a printer serial number, a printer model number, printer ink used, date and time of print job, user name and/or user identification number of individual or group printing or requesting printing of the document 52, number of pages in a document 52 and/or print job, half-tone screen pattern, paper weight/type, etc. The second tag may include security information regarding the identity and location of the document 52 and/or the identity and location of the container 58 for purposes of actively tracking documents, print jobs, and/or containers. More specifically, partial or complete page content (e.g., print content) of the document 52 may be stored as data and/or metadata on the second tag. Further, the second tag may store complementary encryption data to secure and/or decode the stored page content. In this manner, the partial or complete page content for any one or more pages of the document 52 may be securely stored as data and/or metadata in the tags 10, 60 for subsequent retrieval and printing.

In embodiments, the tags 10, 60 may have the capability to be read together at a large distance (e.g., far field), or to be read as a single item and separate from other tags 10, 60 located close by (e.g., near field). More specifically, a given document 52 or print job may include a first tag 10 having the capability to be read by the reader 22 via far field reading and a second tag 10 having the capability to be read by the reader 22 via near field reading. Similarly, the container 58 may include a first tag 60 having the capability to be read by the reader 22 via far field technology and a second tag 60 having the capability to be read by the reader 22 via near field reading.

Because tags 10, 60 are read together in the same RF field, the tags 10, 60 may compete to transmit data at the same time. To prevent this, the tags 10, 60 may employ an anti-collision technique, which allows the reader 22 (FIG. 2) to receive data from each tag 10, 60 on a one-by-one basis. Any suitable anti-collision technique may be employed. For example, a so-called “gap-pulse” technique may be used wherein, in response to the receiver 34 detecting signal collision from competing tags 10, 60, the microcontroller 36 causes the transmitter 30 to transmit a gap pulse via antenna 24. When each tag 10, 60 recognizes the gap pulse, it ceases further transmission of data until it counts a randomly generated number. Each tag 10, 60 will finish counting the number in different time and, as a result, will transmit its data at a different time.

FIG. 4 shows schematically the components and operation of the RFID enabled printer 44. The RFID tags 10 are created and attached to the documents 52 at the time of printing in a non-intrusive operation. As shown, the computer 42 prepares or publishes the document file 62 that communicates both the printable content of the document and an RFID taggable content to the print controller 50. The printable content is normally created at the computer 42 and is stored in the database 40 as an electronic copy of the document 52. The taggable content may be created by the computer 42 and may also be stored within the database 40. The taggable content includes appropriate RFID indicator markings which are indicative of the identity and location of the document 52 when placed inside a container 58. The user or creator loads the document file 62 appropriately so that it can be leveraged or used by all the day-to-day office applications from which printing can be invoked. Usually, at the time of printing, any office application can be employed to print the document 52.

The database 40 contains all of the information extracted from the document 52 received by the controller 50 such as electronic copy of the document, the indexed content such as document ID, summarized content, key words in the document, customized data such as variable print data, meta-data such as username, time of printing, job data, subject, distribution list, number of copies made or to be made, etc. It is this database that helps to deal with the size of the indexed data, that is, if the size of the data is too large to fit into the RFID tag memory, only an appropriate URL or a pointer will go on the RFID memory and that pointer will point to the content stored in the database 40. The database 40 may be associated with the computer 42 as shown in FIGS. 3 and 4 or it may be located in another area or part of the system, for example, the database may be located inside the printer 44.

The document file 62 computes the markings or indexing which include all of the key terms included in the document, compressed byte-stream of the entire content or the content as-is, summary of the content, any automated classification information, subject, key word, author, etc. In general, any of the electronic indexing techniques can be employed to create the taggable content of the RFID tag 10. The document file 62 adds all the index information with clear identification marks into the same file that includes the traditional printable content. The document file 62 can also be configured to produce an interface 64 associated with the host computer 42 for the user's input of any desired modification of the RFID content.

Once the print job has been created, the document file 62 is transferred to the print controller 50 inside the printer 44. The print controller 50 parses the print job and identifies the RFID taggable content 66 and the printable content 68. The print controller 50 delivers the printable content 68 in a traditional way to the printing or marking device 70 and the RFID content 66 to the RFID writer 46. The marking device 70 prints the printable content onto plain paper from the paper supply 72 while the RFID writer 46 electronically embeds the applicable indexing data onto a blank RFID tag 10 from the tag supply 74. The RFID tag dispenser 48 attaches a pair of data loaded RFID tags 10 onto the printed document 52, ideally on the back side of the document as described above. The RFID tags 10 may be allocated to any specific page, the first or last page, for example, and can be attached to either side of the printed document.

The RFID tags 10 may be attached to the document 52 by an adhesive, by a removable adhesive, by a magnetic material, or by an embedding procedure. Attachment may be permanent or removable. The RFID tags 10 may be embedded to a surface of the document 52 using a process such as Printed Organic Electronics (POE) using a reel-to-reel fabrication process to print the RFID tags 10 on a writing surface.

In the embodiment illustrated, the tag dispenser 48 is located between the printing or marking device 70 and the printer output 54 so that RFID tags 10 may be attached to the document 52 as it exits the printer 44. In certain embodiments, however, the tag dispenser 48 may be independent of the printer 44, located either ahead of the printer or after the printer, in the disclosed system. In fact, the tag dispenser 48 may be eliminated altogether in a system that employs a medium, such as paper sheets, that are manufactured with an RFID tag already attached to or embedded within the medium at the paper mill. The tag dispenser 48 also would not be required in systems employing a printer 44 capable of printing the RFID tag directly onto the sheet medium during the printing process. In all such cases, of course, the printer 44 may still employ an RFID writer for electronically loading the indexed data and/or other information onto the printed RFID tag.

The RFID tags 60 can be created for the container 58 shown in FIG. 3 using standard writing processes or by using the above described printing operation that is employed for creating and attaching document tags. The folder tags 60 can describe the overall nature of the documents as well as the class/category of the documents to be contained in each folder.

In embodiments, one or more RFID readers (not explicitly shown) may be embedded within the container 58 to detect and read all identifiable tags 10 inside the container 58. Further, one or more RFID writers (not explicitly shown) may be disposed within the container 58 for addressing, installing or changing the stored data within each RFID tag 10 relative to the identity and location of each document 52. A suitable two-way communication device (e.g., a transceiver) may also be disposed within the container 58 (for wirelessly receiving and transmitting data between the database 40 and RFID tags 10. In this scenario, the tags 10, 60 may employ an anti-collision technique, which allows the reader to receive data from each tag 10, 60 on a one-by-one basis. Any suitable anti-collision technique may be employed.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for automatically tracking documents printed from a printing device, comprising:
a database adapted to maintain data corresponding to the identity and location of at least one document, the at least one document having at least one page;
a processor in operative communication with the database to provide a document file containing both a printable content and an RFID taggable content, the processor configured to provide the printable content to the printing device and the taggable content to an RFID tag writer, the RFID tag writer adapted to install diagnostic data corresponding to the printing device on at least one of a first RFID tag and a second RFID tag and security data corresponding to the at least one document on at least one of the first and second RFID tags;
a container configured to retain the at least one document; and
an RFID tag dispenser configured to attach the first RFID tag to at least one page of the at least one document and the second RFID tag to at least one page of the at least one document.

2. A system for automatically indexing documents printed from a printing device according to claim 1, wherein the at least one document is a print job printed from the printing device.

3. A system for automatically indexing documents printed from a printing device according to claim 1, further comprising at least one RFID tag attached to the container and configured to store data corresponding to the identity and location of at least one of the container and the at least one document retained in the container.

4. A system for automatically indexing documents printed from a printing device according to claim 1, wherein at least one of the first and second RFID tags stores data corresponding to the identification of the at least one page to which it is attached.

5. A system for automatically indexing documents printed from a printing device according to claim 1, wherein the first and second RFID tags are attached to one of a first page, a last page, and a random page of the at least one document.

6. A system for automatically indexing documents printed from a printing device according to claim 1, wherein the first and second RFID tags are attached to the at least one page prior to being printed from the printing device.

7. A system for automatically indexing documents printed from a printing device according to claim 1, wherein the first and second RFID tags are attached to the at least one page during printing from the printing device.

8. A system for automatically indexing documents printed from a printing device according to claim 1, wherein the first and second RFID tags are attached to the at least one page subsequent to being printed from the printing device.

9. A system for automatically indexing documents printed from a printing device according to claim 1, wherein the printable content includes at least one barcode containing the taggable content of at least one of the first and second RFID tags.

10. A system for automatically indexing documents printed from a printing device according to claim 1, further comprising at least one RFID tag reader configured to read at least one of the first and second RFID tags to track the movement of the at least one document.

11. A system for automatically indexing documents printed from a printing device according to claim 10, wherein the at least one RFID tag reader is configured to read at least one of the first and second RFID tags via near field technology and at least one of the first and second RFID tags via far field technology.

12. A system for automatically indexing documents printed from a printing device according to claim 10, wherein the at least one RFID tag reader is disposed within the printing device.

13. A system for automatically indexing documents printed from a printing device according to claim 10, wherein the at least one RFID tag writer and at least one RFID tag reader are disposed within the container.

14. A system for automatically tracking print jobs printed from a printing device, comprising:
a database adapted to maintain data corresponding to the identity and location of at least one print job, the at least one print job having at least one page;
a processor in operative communication with the database to provide a document file containing both a printable content and an RFID taggable content, the processor configured to provide the printable content to the printing device and the taggable content to an RFID tag writer, the RFID tag writer adapted to install diagnostic data corresponding to the printing device on at least one of a first RFID tag and a second RFID tag and security data corresponding to the at least one print job on at least one of the first and second RFID tags;
a container configured to retain the at least one print job;
an RFID tag dispenser configured to attach the first and second RFID tags to the at least one page of the at least one print job; and
at least one RFID tag reader configured to read at least one of the first and second RFID tags to track the movement of the at least one print job.

15. A method for automatically tracking documents printed from a printing device, comprising:
maintaining data corresponding to the identity and location of at least one document having at least one page;
providing a printable content to the printing device and a taggable content to an RFID tag writer;
installing diagnostic data corresponding to the printing device on at least one of a first RFID tag and a second RFID tag and security data corresponding to the at least one document on at least one of the first and second RFID tags;
retaining the at least one document in a container;
attaching the first RFID tag to at least one page of the at least one document and the second RFID tag to at least one page of the at least one document; and
reading at least one of the first and second RFID tags to track the movement of the at least one document.

16. A method for automatically tracking documents printed from a printing device according to claim 15, further comprising reading at least one of the first and second RFID tags via near field technology and at least one of the first and second RFID tags via far field technology.

17. A method for automatically tracking documents printed from a printing device according to claim 15, wherein the at least one document is a print job printed from the printing device.

18. A method for automatically tracking documents printed from a printing device according to claim 15, further comprising attaching at least one RFID tag to the container, the RFID tag configured to store data corresponding to the identity and location of at least one of the container and the at least one document retained in the container

19. A method for automatically tracking documents printed from a printing device according to claim 15, further comprising installing data corresponding to the identification of the at least one page on one of the first and second RFID tags.

20. A method for automatically tracking documents printed from a printing device according to claim 15, further comprising attaching the first and second RFID tags to one of a first page, a last page, and a random page of the at least one document.
